(19) United States
(12) Patent Application Publication
(10) Pub. No.: US 2013/0107108 A1
(43) Pub. Date: May 2, 2013

(54) CAMERA MODULE HAVING A SWITCHABLE FOCAL LENGTH

(71) Applicants: Udo Schauss, Waldbockelheim (DE); Josef Staub, Ockenheim (DE); Lingli Wang, Bad Kreuznach (DE)

(72) Inventors: Udo Schauss, Waldbockelheim (DE); Josef Staub, Ockenheim (DE); Lingli Wang, Bad Kreuznach (DE)

(73) Assignee: JOS. SCHNEIDER OPTISCHE WERKE GMBH, Bad Kreuznach (DE)

(21) Appl. No.: 13/514,596

(22) PCT Filed: Apr. 18, 2011
(86) PCT No.: PCT/EP2011/056147

§ 371 Date: Dec. 26, 2012

(30) Foreign Application Priority Data
May 11, 2010 (DE) 10 2010 020 243.6

(51) Int. Cl. G03B 3/00

(52) U.S. Cl. CPC G03B 3/00
USPC 348/360

(57) ABSTRACT

A camera module for imaging an object onto an image sensor and having at least two carrier plates, wherein a plurality of basic lenses are arranged on one carrier plate and a plurality of lens attachments are arranged on the second carrier plate. The carrier plates are arranged one above the other in two planes and are horizontally displaceable in order to position different basic lenses and vehicle attachments in the beam path and thus combine them with one another. One embodiment of the proposed solution comprises for example, six basic lenses and four telenegative lens attachments making it possible to realize 30 discretely switchable different focal lengths and to achieve a quasi-zoom having small dimensions.

### FIELD OF THE INVENTION

The invention relates to a camera module having a switchable focal length for imaging an object onto an image sensor.

### PRIOR ART

The tendency in the development of optical modules, in particular for mobile communication devices (cell phones), is increasingly directed to as flat a design as possible. In this case, the implementation of a multiple optical zoom, inter alia, is also increasingly at the center of the work of the developers. The continuously rising demands that are made of the flattest possible design of the modules set limits, however, for the previously used devices and systems, particularly also with regard to the variability of the focal length.

An optical system with a zoom function is described in a known system of the type mentioned above (US 2008/0049334 A1). The system described has a first fixed lens group with a totally reflecting prism that deflects the image-side optical axis by 90 degrees in the direction of the image sensor. The first lens group is positive. Three further lens groups are arranged downstream of the prism on the optical axis in the direction of the image sensor. The fourth optical group is likewise fixed. The zoom is implemented by means of the movable second and third lens groups. The implementation of a particularly flat design is, however, limited in this arrangement of the optical system.

Another document (US 2008/0007623) describes a camera module having two carrier plates that are arranged one above another in two planes. Each carrier plate has four lenses that are symmetrically arranged fixedly next to one another and correspond to one another. The focusing of the four beam paths onto four defined regions of an image sensor is performed via a shift device. Here, the beam path traverses various color filters such that only monochrome images are imaged onto the four regions of the image sensor. These four images are assembled electronically in a signal processing system to form a high resolution color image.

U.S. Pat. No. 7,495,852 B2 describes a zoom objective, for example for a mobile phone, that has an arrangement of a plurality of lenses combined with one another. By moving perpendicular to the optical axis of the recording device (camera), the lenses can be inserted into or removed from the optical axis. It is preferred in this case for individual lenses or a plurality of lenses to be arranged fixedly in lens arrays that are arranged in a plurality of planes parallel to the optical axis. The various focal lengths of the objective are implemented by respectively introducing a lens into the optical axis simultaneously from one or more of the lens arrays arranged one above another. The device is configured in such a way that it is possible thus to implement different lens combinations in the optical axis. The focusing of the system is performed by means of a special lens group that can execute a movement along the optical axis. Detailed data relating to the optical characteristics of the lenses or possible lens combinations and the focal lengths that can thereby be obtained are not disclosed in the above named document. It may be supposed that the imaging characteristics become deficient when individual lenses are combined to form different lens combinations. Furthermore, the overall length of the objective is relatively long, so that the proposed objective is hardly suitable for cell phones.

A multiplicity of mobile communications devices having a photo function has fixed focal lengths almost exclusively, since zoom objectives with a zoom factor of greater than 2 have a relatively large overall height. In the case of a photo function of fixed focal length, “zooming” is performed electronically, which leads to a very pronounced reduction in the imaging performance. Thus, for example, a three-megapixel camera provides a camera with VGA resolution, which generally corresponds to a resolution of 640×480 pixels. Here, VGA (Video Graphics Array) denotes a computer graphics standard that defines specific combinations of image resolution and color number (color bit depth) and repetition frequency, wherein a greater pixel depth or color resolution (up to 32 bits), that were not originally available, are usually employed.

### OBJECT

It is an object of the invention to specify a camera module of small dimensions that implements a plurality of discrete switchable focal lengths in conjunction with good imaging quality.

### SOLUTION

This object is achieved by the inventions having the features of the independent claims. Advantageous developments of the inventions are characterized in the subclaims. The wording of all the claims is hereby included in this description by reference.

The invention relates to a camera module for imaging an object onto an image sensor, light traversing a beam path between the object and the image sensor, the camera module having the following:

a) at least two carrier plates,
a1) the first carrier plate bearing a plurality of basic objectives with an optical axis;
a2) the second carrier plate bearing a plurality of objective downstream attachments;

b) each carrier plate having a preferred plane that is perpendicular to the optical axis;

c) the position of the carrier plates being variable in their preferred plane in such a way that different basic objectives and objective downstream attachments can be positioned in the beam path;

d) the carrier plates being arranged one above another in the beam path;

e) the basic objectives and the objective downstream attachments being designed in such a way that, by positioning different lens combinations of
e1) a basic objective alone, or
e2) a basic objective with an objective downstream attachment,
   it is possible to produce in the beam path a plurality of imaging optical systems of different focal lengths, the optical systems being suitable for imaging the object onto the image sensor; and

f) the basic objectives and the objective downstream attachments being designed in such a way that it is possible to implement more lens combinations of different focal lengths than the number of basic objectives or objective downstream attachments on one of the carrier plates.

By way of example, it is sensible here to arrange the plurality of basic objectives symmetrically in a row relative to one another on a carrier plate, and to arrange a plurality of downstream objective attachments in the same way on a second carrier plate.

The position of the carrier plates is typically changed by displacing the carrier plates in their preferred plane in order to place another basic objective or another objective downstream attachment in the beam path.

The basic objectives are fixedly inserted into the carrier plate at different height levels for the purpose of adapting to the optical requirements. The downstream attachments are all regularly fixed at the same height level in their carrier plate.

An advantageous embodiment of the proposed solution having, for example, six basic objectives and four telenegative objective downstream attachments enables for example the implementation of 30 discretely switchable different focal lengths. It is thereby possible to achieve a quasi-zoom in conjunction with small dimensions. The proposed system can exhibit outstanding imaging performances.

The camera module should advantageously have a light input device that faces the object and through which the light from the object enters the camera module. It is sensible here to design the light input device as an optically neutral transparent plate. This can, for example, be a simple protective glass.

In an advantageous embodiment, the camera module can have a basic objective that, starting from the object side, i.e. from left to right, comprises the following lenses:

a) a first plano-convex lens, the plane surface of the lens being averted from the object side;

b) a second plano-concave lens,

the plane surface of this lens being averted from the image side;

c) a diaphragm; and

d) a third plano-convex lens, the plane surface of the lens being averted from the image side.

The first two lenses are typically cemented to one another.

It is advantageous that implementing the described optical module, while retaining the desired compactness, requires only a design having as few lenses as possible. This could be achieved by the selection of highly refractive materials (nₑ>1.65) for the first cemented component of the basic objective. Furthermore, by introducing plane surfaces into the basic objective it proved possible to optimize the costs and to alleviate tolerances.

It is also advantageous if the objective downstream attachment has telenegative optical characteristics. In general, a telenegative is an assembly of negative refractive power downstream of a basic objective, intended to increase the focal length of the basic objective.

An advantageous embodiment of a telenegative objective downstream attachment comprises, starting from the object side, i.e. from left to right, the following lenses:

a) a first bi-concave lens, and

b) a second meniscus lens, which is positive as a rule,

the concave surface of the meniscus lens being averted from the object side.

The telenegative downstream attachments are advantageously composed only of a cemented component whose Abbe numbers should differ as greatly as possible. The Abbe numbers of the first bi-concave lens and of the second meniscus lens should preferably differ by at least a factor of 1.5. The radius of the cemented surface can thereby be kept large. In other words: the cemented surface is only slightly curved. This has the advantage, in turn, that the second, positive lens is also sufficiently thick at the edge.

It is advantageous if, in a plan view, the carrier plate has, in particular, a rectangular shape or a circular shape, and if the position of the carrier plate is changed by a linear displacement and/or by a rotational movement in the plane of the carrier plate. That is to say, the carrier plates can be configured as a rectangle, but also, for example, as a circular disk. When a carrier plate is configured as a circular disk, the insertion of a desired lens combination (basic objective or objective downstream attachments) into the beam path is performed by means of a controlled rotational movement of the appropriate carrier plate.

The two carrier plates are arranged in different planes, i.e. the basic objectives above and the carrier plate with the objective downstream attachments below. Each of the carrier plates can be moved or displaced perpendicular to the optical axis. The possible movements of the carrier plates relative to one another are configured such that it is possible to introduce each of the basic objectives into the beam path on their own or in combination with one of the objective downstream attachments.

The insertion of only one basic objective alone, without a downstream attachment, into the beam path can be performed in such a way that either the carrier plate with the objective downstream attachments is moved completely out of the beam path, or the second carrier plate comprises a void (e.g. a bore) that permits the beams to pass through the carrier plate in an optically indifferent fashion free from obstacles.

It is also particularly simple if the imaging system can be focused by means of changing the position of the image sensor along the optical axis. Such a functionality is currently already present in many cell phones.

Further details and features emerge from the following description of preferred exemplary embodiments in conjunction with the subclaims. In this case, the respective features can be implemented on their own or in combination with one another. The possibilities of achieving the object are not restricted to the exemplary embodiments. Thus, for example, range specifications always comprise all—unmentioned—intermediate values and all conceivable subintervals.

The exemplary embodiments are illustrated schematically in the figures. Illustrated schematically in this case are, inter alia, lens combinations of two basic objectives or lens combinations of these two basic objectives with one telenegative downstream attachment each. For further lens combinations or telenegative downstream attachments, only the optical data are respectively given in tables. Identical reference numerals in the individual figures in this case denote elements that are identical or functionally identical or correspond to one another with regard to their functions. Specifically:

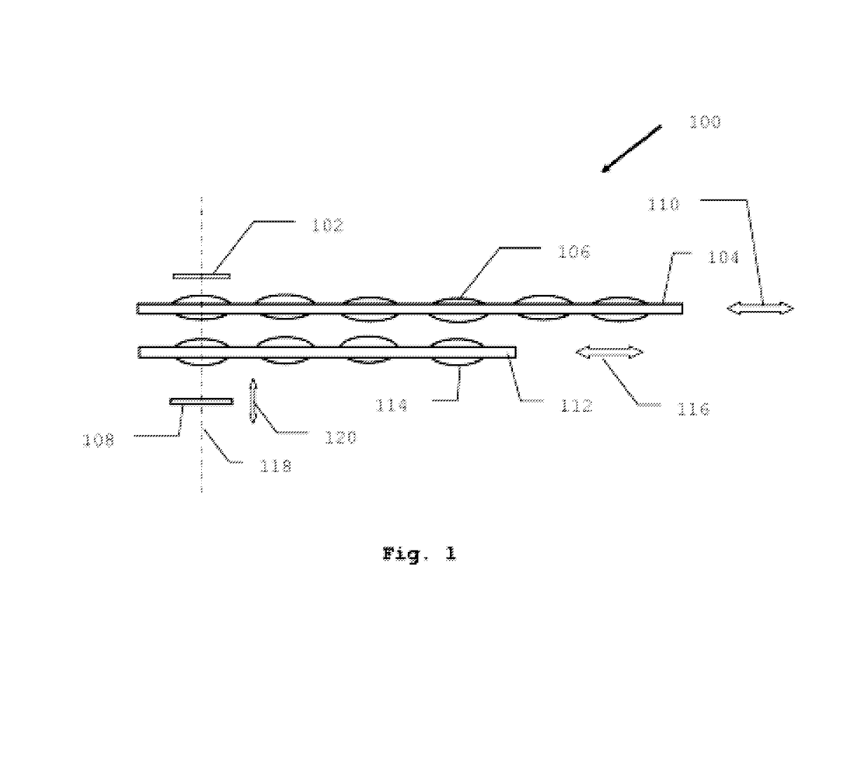

FIG. 1 shows a schematic of an advantageous embodiment of a camera module having a lens array comprising six basic objectives, and a lens array comprising four telenegative downstream attachments, arranged in two planes;

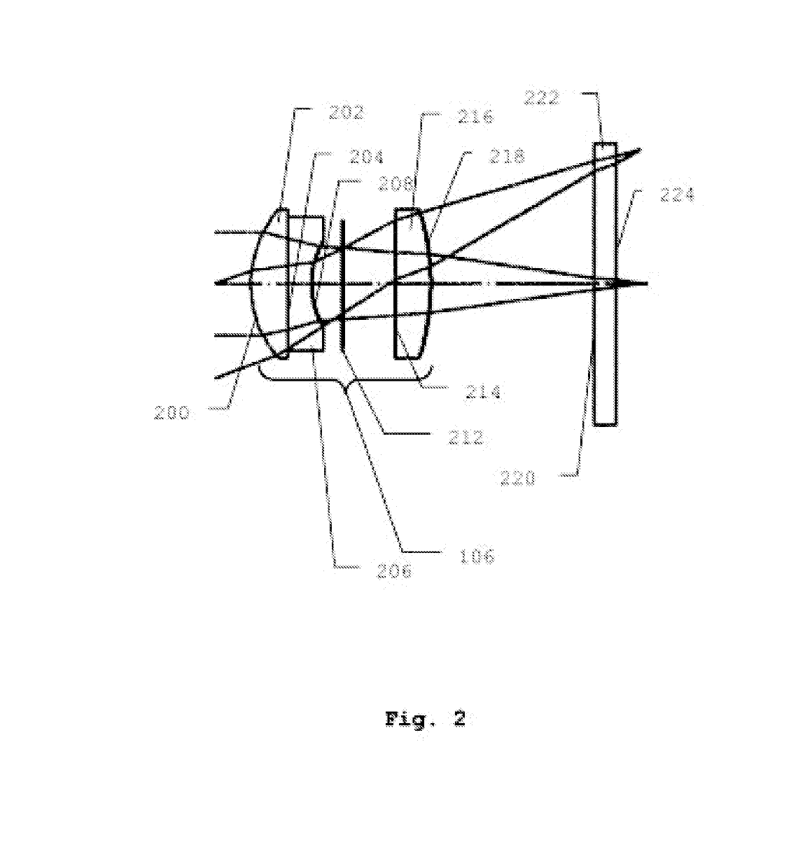

FIG. 2 shows a schematic of the lens arrangement of an 8 mm basic objective;

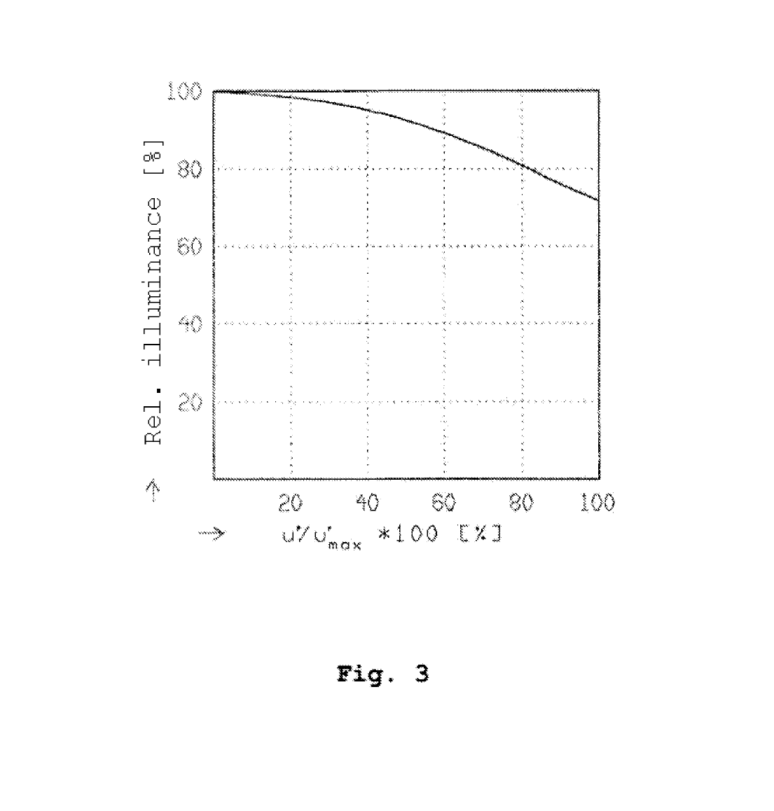

FIG. 3 shows the relative illuminance of the basic objective in accordance with FIG. 2;

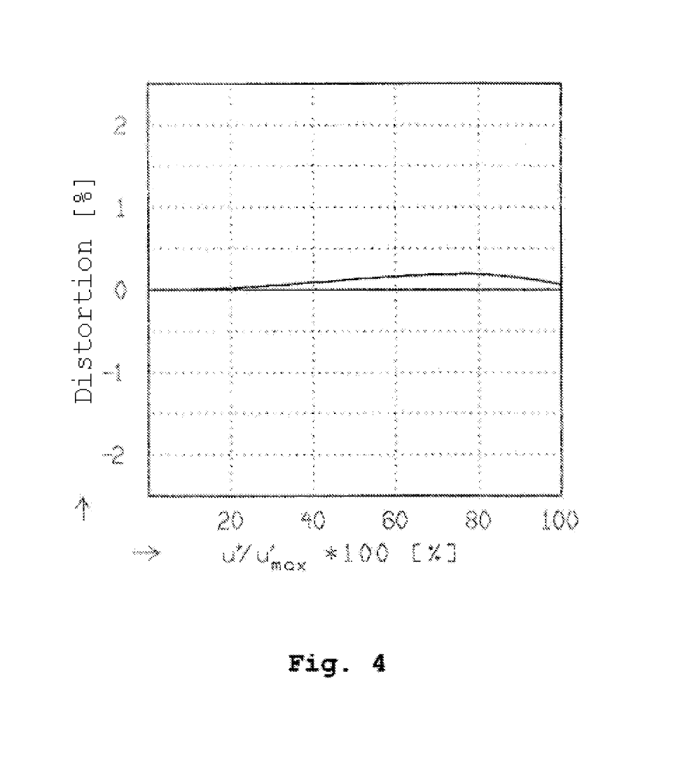

FIG. 4 shows the distortion of the basic objective in accordance with FIG. 2;

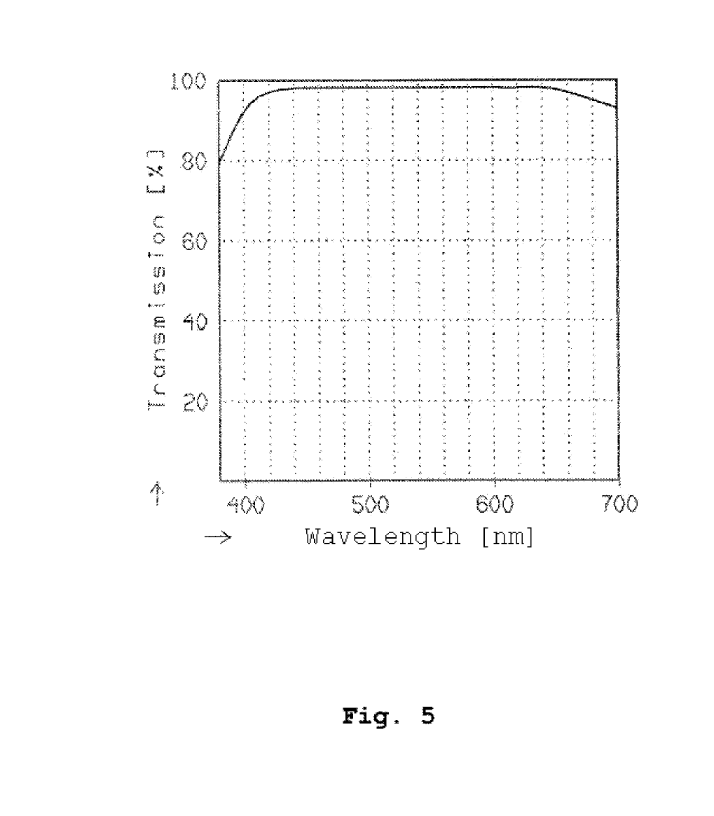

FIG. 5 shows the transmission of the basic objective in accordance with FIG. 2;

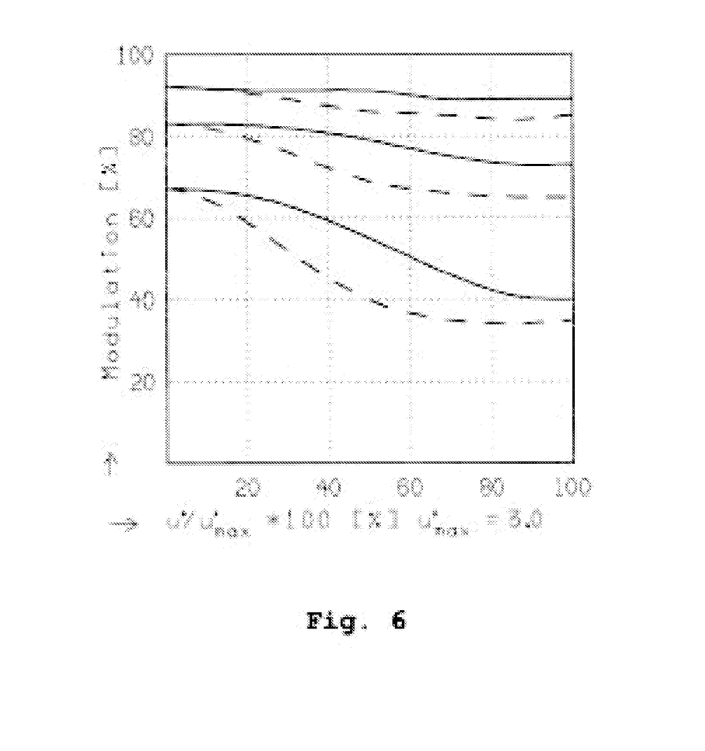

FIG. 6 shows the modulation of the basic objective in accordance with FIG. 2;

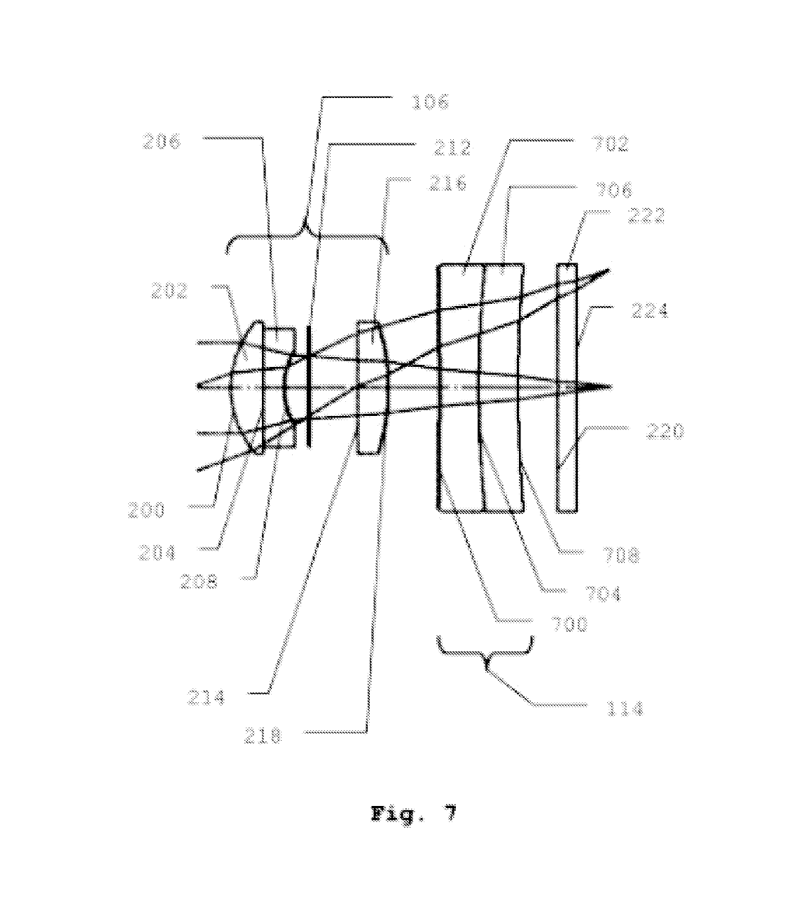

FIG. 7 shows a schematic of the lens arrangement of the 8 mm basic objective in accordance with FIG. 2 with a first telenegative downstream attachment (TN1);

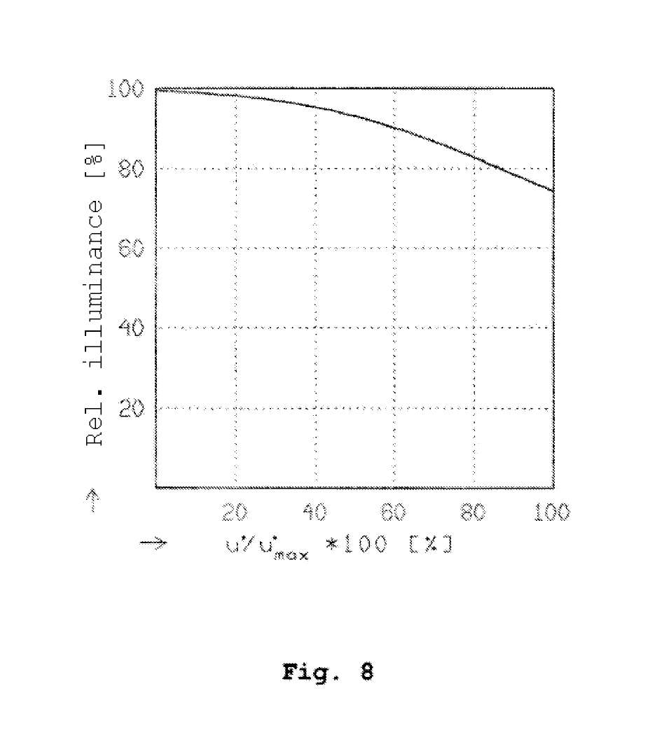

FIG. 8 shows the relative illuminance of the lens arrangement in accordance with FIG. 7;

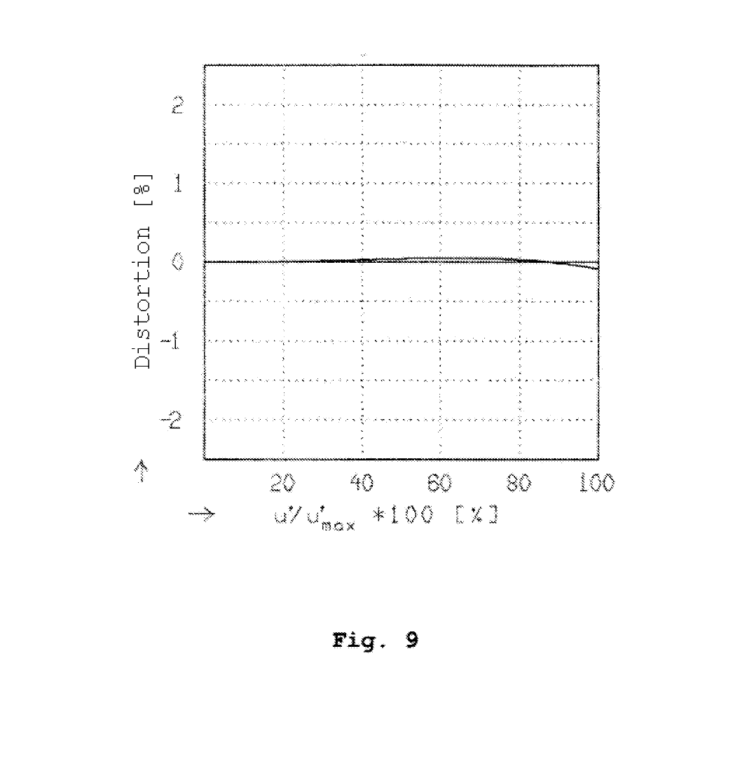

FIG. 9 shows the distortion of the lens arrangement in accordance with FIG. 7;

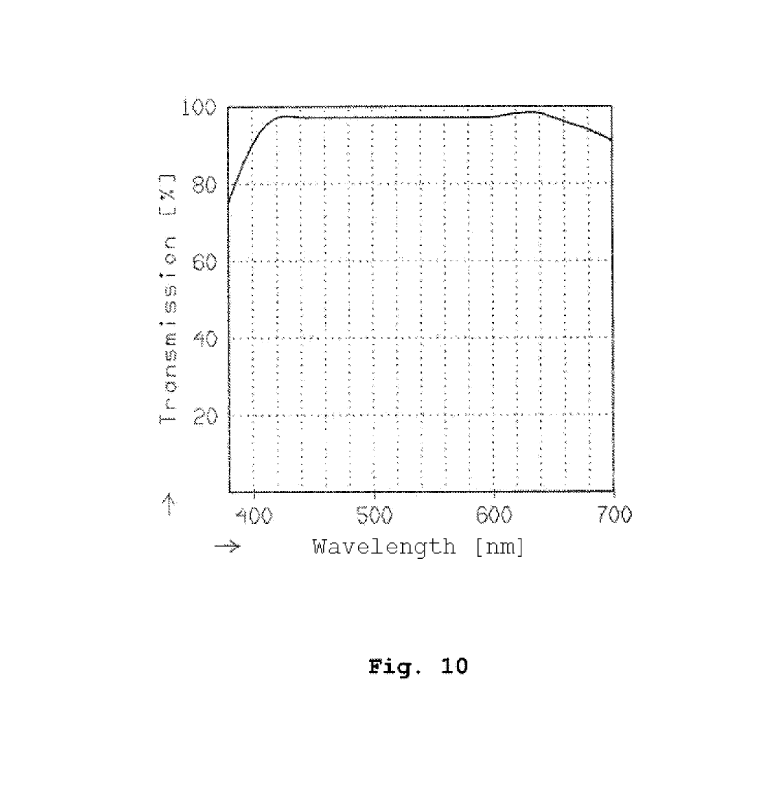

FIG. 10 shows the transmission of the lens arrangement in accordance with FIG. 7;

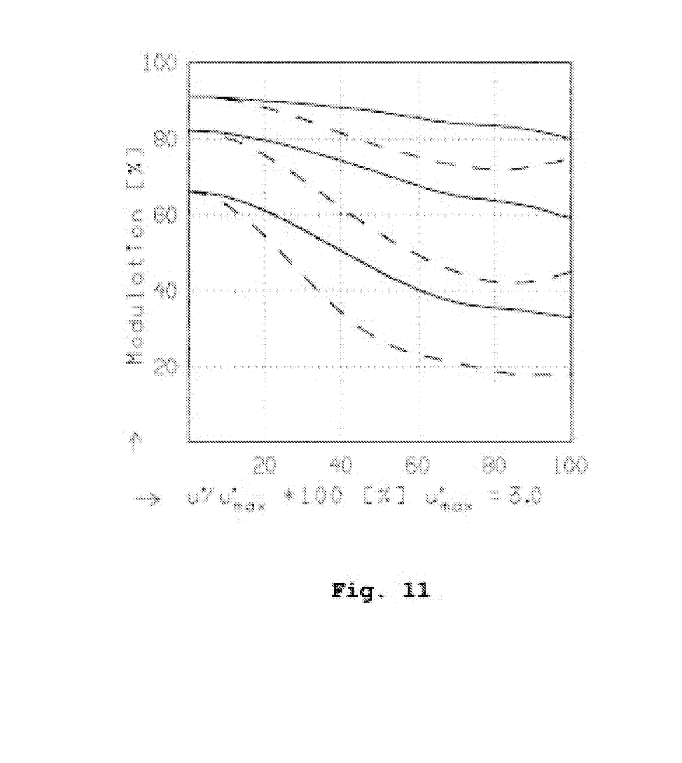

FIG. 11 shows the modulation of the lens arrangement in accordance with FIG. 7;

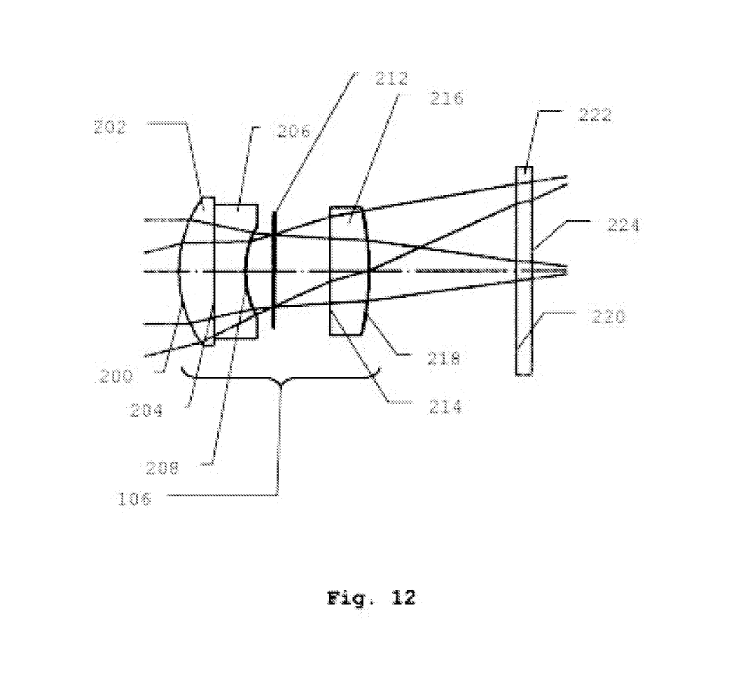

FIG. 12 shows a schematic of the lens arrangement of a 12 mm basic objective;

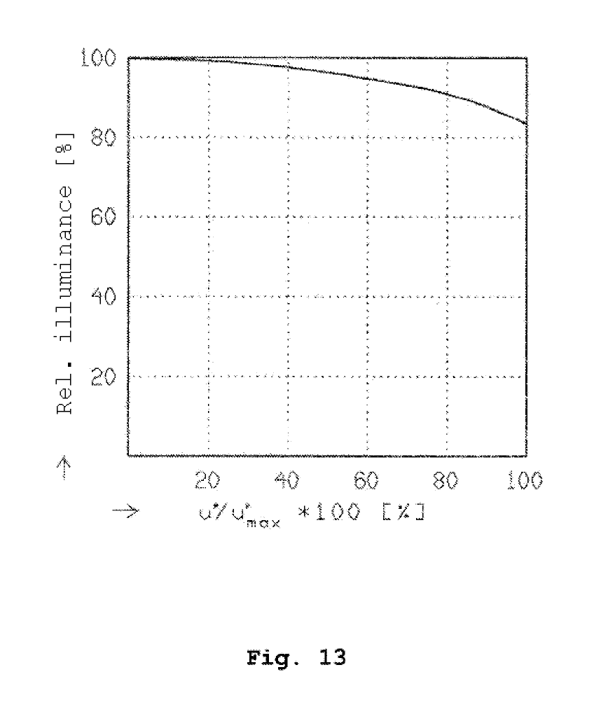

FIG. 13 shows the relative illuminance of the basic objective in accordance with FIG. 12;

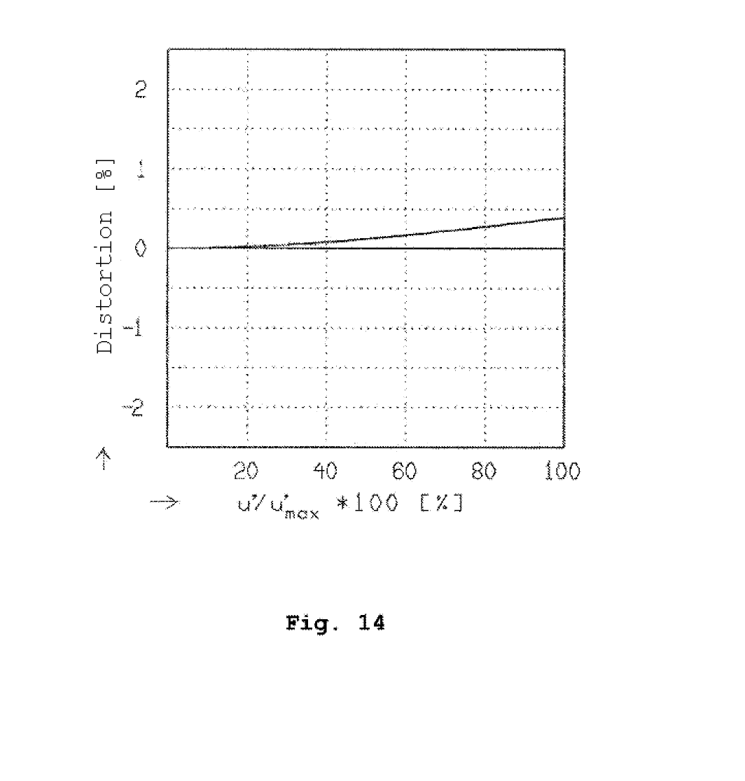

FIG. 14 shows the distortion of the basic objective in accordance with FIG. 12;

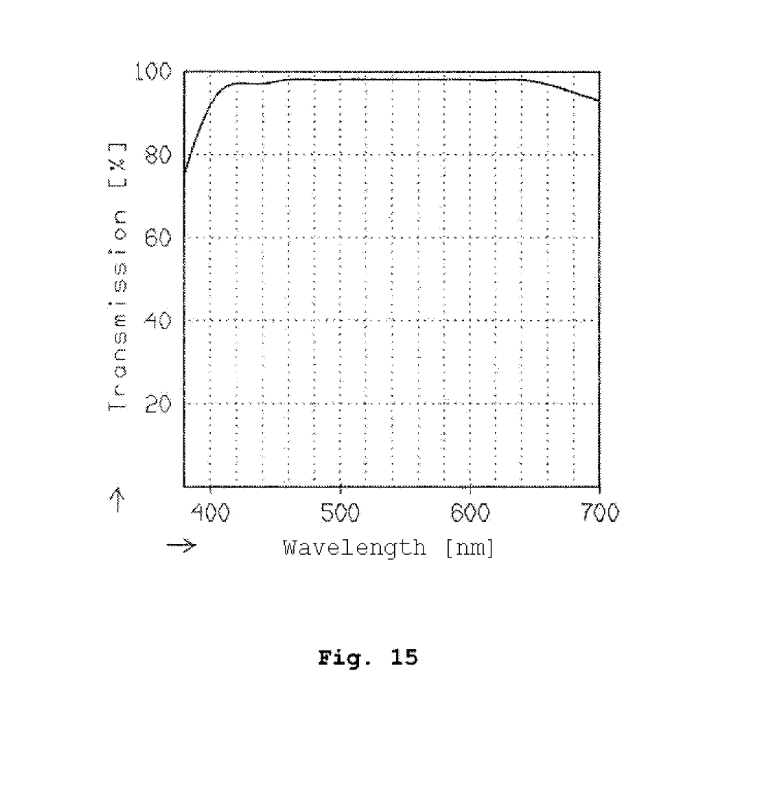

FIG. 15 shows the transmission of the basic objective in accordance with FIG. 12;

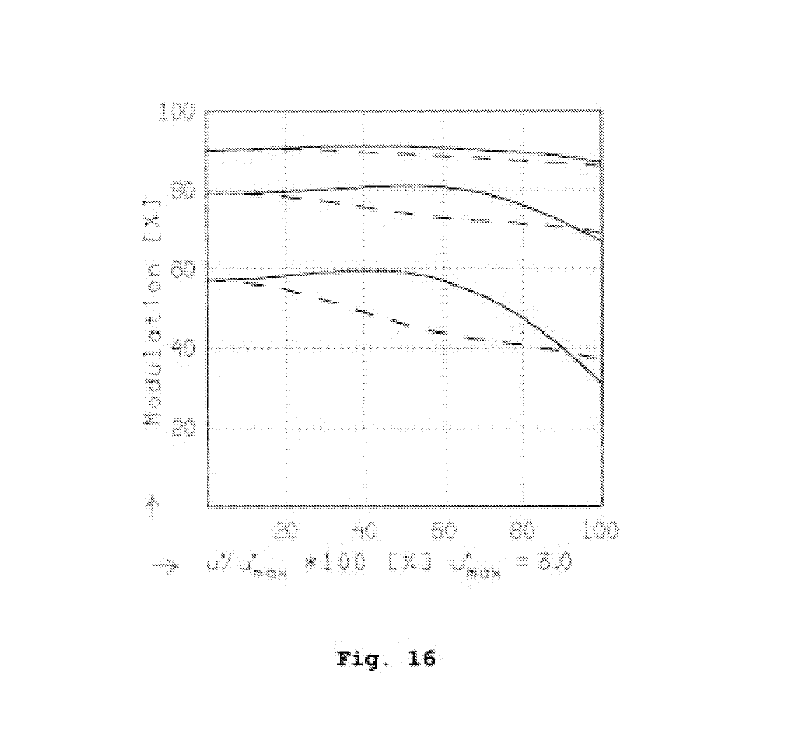

FIG. 16 shows the modulation of the basic objective in accordance with FIG. 12;

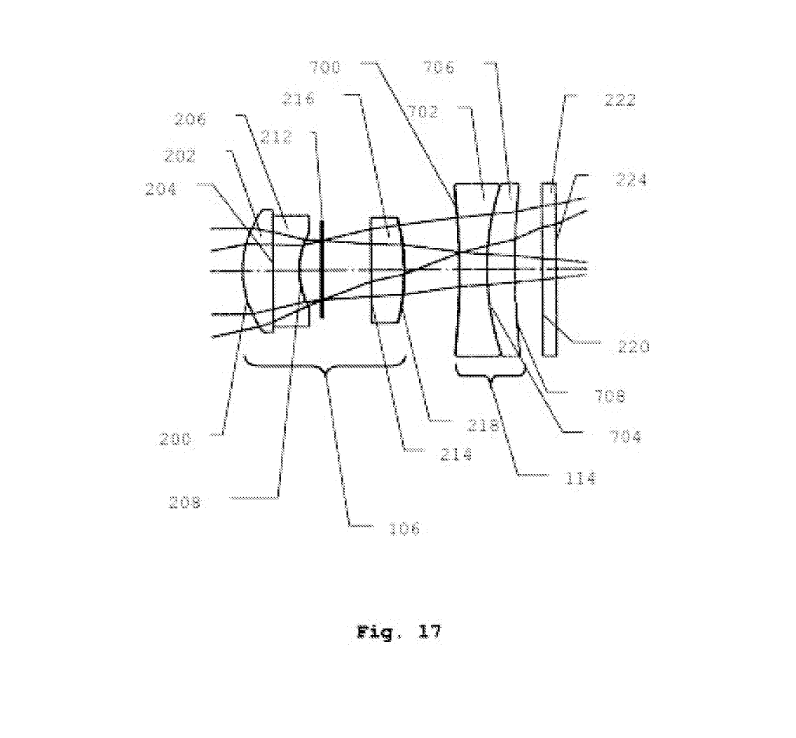

FIG. 17 shows a schematic of the lens arrangement of the 12 mm basic objective in accordance with FIG. 12 with a second telenegative downstream attachment (TN2);

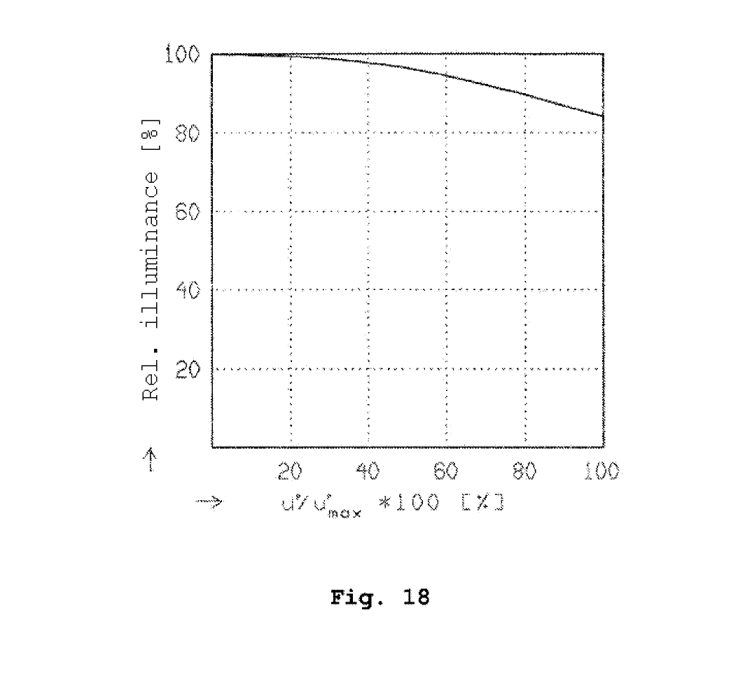

FIG. 18 shows the relative illuminance of the lens arrangement in accordance with FIG. 17;

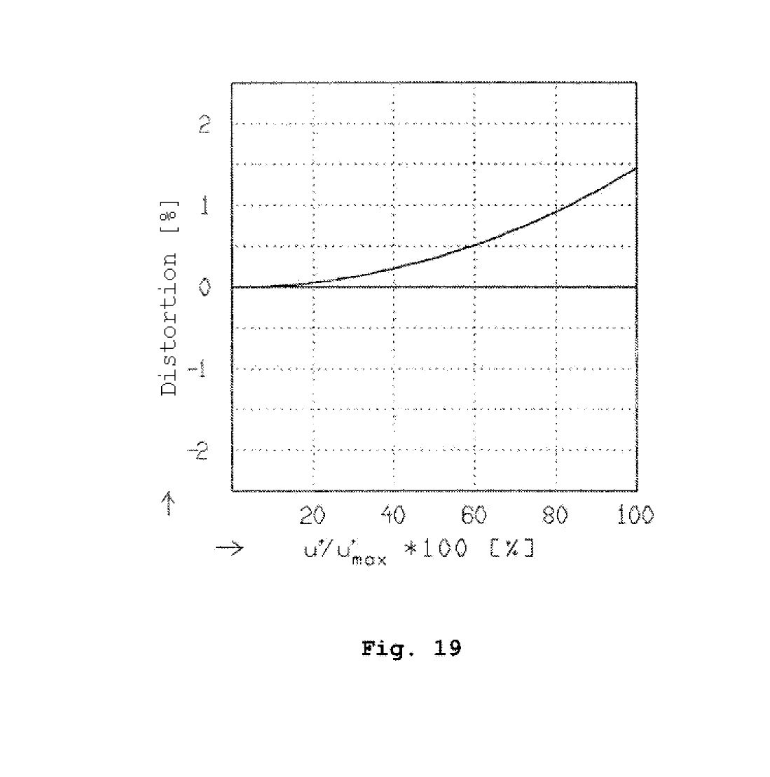

FIG. 19 shows the distortion of the lens arrangement in accordance with FIG. 17;

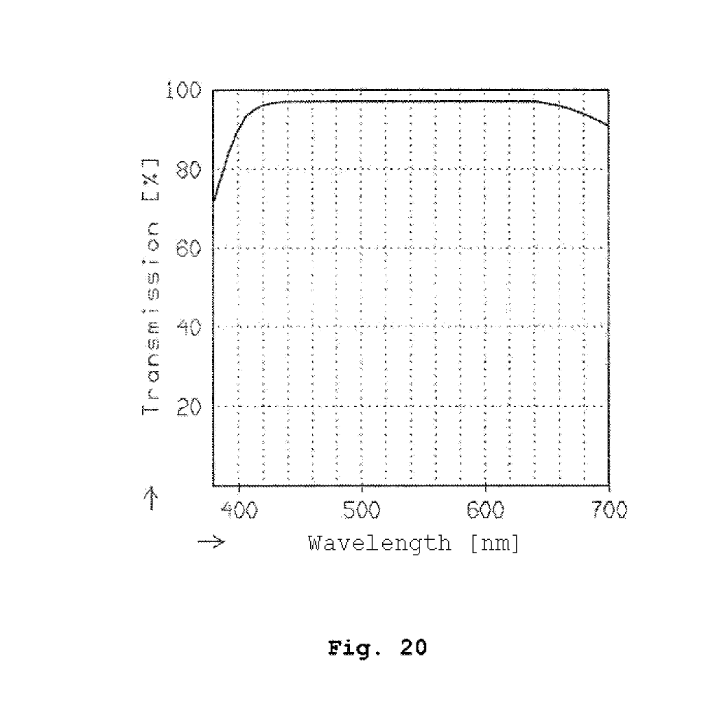

FIG. 20 shows the transmission of the lens arrangement in accordance with FIG. 17; and

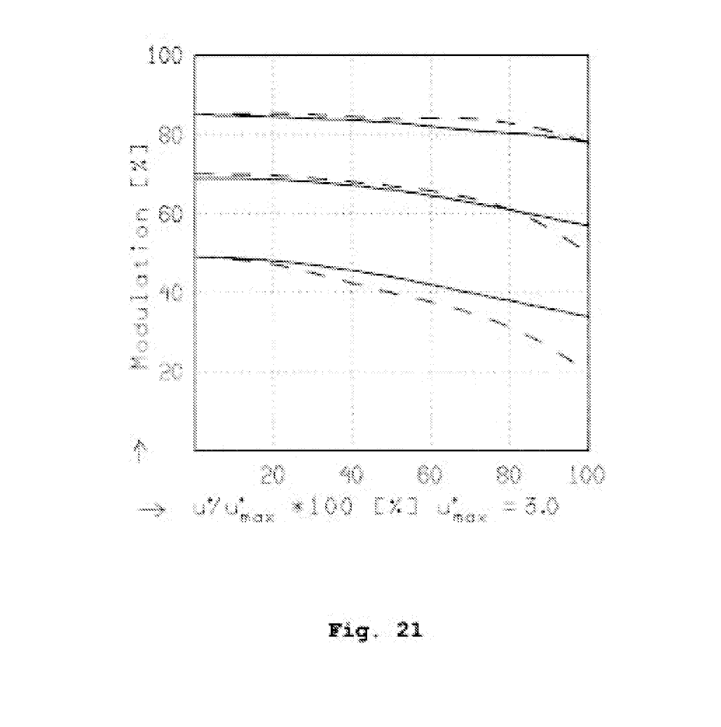

FIG. 21 shows the modulation of the lens arrangement in accordance with FIG. 17.

The technical data of the lens combinations of six proposed basic objectives and four telenegative downstream attachments TN1 to TN4 are listed in tables 2 to 11A. Specifically:
table 1 shows a list of the focal lengths that can be implemented with the basic objectives or the combinations composed of basic objective and objective downstream attachment;
table 1A shows a list of the air spaces between the last surface of the basic objectives and the first surface of the objective downstream attachments;
table 2 shows a list of the radii, the thicknesses or air spaces, the refractive indices and the Abbe numbers of the lens combination of a 6 mm basic objective;
table 2A shows a list of the aspheric data of the 6 mm basic objective;
table 3 shows a list of the radii, the thicknesses or air spaces, the refractive indices and the Abbe numbers of the lens combination of a 7 mm basic objective;
table 3A shows a list of the aspheric data of the 7 mm basic objective;
table 4 shows a list of the radii, the thicknesses or air spaces, the refractive indices and the Abbe numbers of the lens combination of an 8 mm basic objective;
table 4A shows a list of the aspheric data of the 8 mm basic objective;
table 5 shows a list of the radii, the thicknesses or air spaces, the refractive indices and the Abbe numbers of the lens combination of a 10 mm basic objective;
table 5A shows a list of the aspheric data of the 10 mm basic objective;
table 6 shows a list of the radii, the thicknesses or air spaces, the refractive indices and the Abbe numbers of the lens combination of a 12 mm basic objective;
table 6A shows a list of the aspheric data of the 12 mm basic objective;
table 7 shows a list of the radii, the thicknesses or air spaces, the refractive indices and the Abbe numbers of the lens combination of a 15 mm basic objective;
table 7A shows a list of the aspheric coefficients of the 15 mm basic objective;
table 8 shows a list of the radii, the thicknesses or air spaces, the refractive indices and the Abbe numbers of the lens combination of a first telenegative downstream attachment TN1;
table 8A shows a list of the aspheric data of the first telenegative downstream attachment TN1;
table 9 shows a list of the radii, the thicknesses or air spaces, the refractive indices and the Abbe numbers of the lens combination of a second telenegative downstream attachment TN2;
table 9A shows a list of the aspheric data of the second telenegative downstream attachment TN2;
table 10 shows a list of the radii, the thicknesses or air spaces, the refractive indices and the Abbe numbers of the lens combination of a third telenegative downstream attachment TN3;
table 10A shows a list of the aspheric data of the third telenegative downstream attachment TN3;
table 11 shows a list of the radii, the thicknesses or air spaces, the refractive indices and the Abbe numbers of the lens combination of a fourth telenegative downstream attachment TN4; and
table 11A shows a list of the aspheric data of the fourth telenegative downstream attachment TN4.

As an example, an advantageous embodiment of the proposed solution with six basic objectives and four telenegative objective downstream attachments enables the implementation of 30 discretely switchable different focal lengths in the range from 5.99 mm to 21.012 mm. It is rendered possible hereby to achieve a quasi 3.5-fold zoom for ⅓″ image sensors (corresponding to a diagonal of the image sensor of 6 mm) with a vertex height of up to 19 mm. That is to say, the distance from the first lens vertex to the recording medium (image sensor) is at most 19 mm. The diameter of the lenses is at most 6 mm.

For this purpose, table 1 sets forth which particular focal lengths can be implemented with these six basic objectives, which are named as exemplary embodiments, and/or combinations of these basic objectives with four, exemplary telenegative objective downstream attachments.

All the basic objectives have the maximum f-number 3.5. In the case of the combinations of a basic objective with an objective downstream attachment, the maximum f-number is calculated from the product of the f-number 3.5 and the multiplication factor, which is implemented by the combination with the respective objective downstream attachment.

For example, the following results in the case of the combination of the 8 mm basic objective with the telenegative downstream attachment TN1:

Focal length of the 8 mm basic objective: 8.022 mm

Focal length for combination with TN1: 8.516 mm

Multiplication factor: 8.516/8.022=1.06

Resulting f-number: 1.06×3.5=3.71

The camera module 100 illustrated schematically in FIG. 1 has a light input device 102, comprising an optically neutral transparent plate, a lens array, which comprises a rectangular plate shaped carrier element (carrier plate) 104 with six basic objectives 106, and an image sensor 108 (generally a CMOS or CCD sensor). The six basic objectives 106 have different focal lengths and are fixedly inserted in a linear fashion into the carrier plate 104 in a row.

A defined distance respectively exists between the lenses 106, these distances generally being equal. The carrier plate 104 with the basic objectives 106 has a horizontal shift function 110 (1D shift), and can be displaced in a longitudinal direction of the camera module 100 (perpendicular to the optical axis 118). The displacement is performed in such a way that respectively one of the six different basic objectives 106 is introduced into the air space between the light input device 102 and image sensor 108 of the camera module 100.

Furthermore, the camera module 100 has a second carrier plate 112, in which four telenegative downstream attachments 114 are arranged. The four telenegative downstream attachments 114 likewise have different optical characteristics and are fixedly inserted into the carrier plate 112 in a linear fashion in a row. All four telenegative downstream attachments 114 are fixedly arranged at the same height in a plane in a linear fashion on the carrier plate in a row. The carrier plate 112 with the four telenegative downstream attachments 114 has a horizontal shift function 116 (1D shift) and can be displaced in a longitudinal direction of the camera module 100. The displacement is performed in such a way that one of the four different telenegative downstream attachments 114 is respectively inserted into the optical axis 118 between the actively used basic objective 106 and the image sensor 108 of the camera module 100. The shift functions 110, 116 of the carrier plate 104, 112 are configured in such a way that each basic objective 106 of the carrier plate 104 can be combined with each telenegative downstream attachment 114 of the carrier plate 112, or that each basic objective 106 can be used to image an object on the image sensor 108 without a telenegative downstream attachment 114 being inserted into the optical axis 118.

By contrast with the four telenegative downstream attachments 114, the six basic objectives 106 are inserted into the carrier plate 104 in such a way that they are fixed at different heights (along the optical axis 118) in order to implement the optical requirements with regard to the combination with the four telenegative downstream attachments 114.

In order to focus the respectively active lens combination, the image sensor 108 is equipped with a shift function 120 that enables it to move along the optical axis 118.

On the basis of the described configuration of the camera module 100, it is possible to implement thirty different focal lengths (see table 1), and thus to produce a discretely switchable zoom in steps of different sizes. In general, the shift functions 110, 116, 118 are activated electronically here, but it is also conceivable to activate them mechanically.

FIGS. 2, 7, 12 and 17 show the lens combinations of two exemplary embodiments (8 mm basic objective and 12 mm basic objective), respectively without or in combination with a telenegative downstream attachment (TN1 and TN2, respectively), which can be implemented, inter alia, by the shift functions of the proposed camera module. The lens combinations illustrated in these figures constitute examples with the same basic design that, however, differ from one another with regard to the focal length to be attained with them. All further lens combinations whose optical data are set forth in tables 1 to 11A also have this same basic design.

The examples, outlined here and in the tables, of basic objectives and telenegative downstream attachments are only examples. It is also possible—using the same basic principles—to implement camera modules with other focal lengths and other quasi zoom values. All dimensional specifications, for example relating to focal lengths or radii in the tables, are scalable in principle for different applications.

In the schematics according to FIGS. 2, 7, 12 and 17, the object (not illustrated) is located respectively on the left, and the image sensor 108 (not illustrated) on the right.

In these four exemplary embodiments, the lens combination of the insertable basic objective 106 of the camera module 100 respectively comprises the following elements, in the sequence from the object side to the image sensor 108, i.e. from left to right:

a) a first plano-convex lens 202,

the plane surface 204 of the lens 202 being averted from the object side;

b) a second plano-concave lens 206,

the plane surface 204 of the lens being averted from the image side;

c) a diaphragm 212, and

d) a third plano-convex lens 216, the plane surface 214 of the lens 216 being averted from the image side.

Respectively arranged directly upstream of the image sensor is a transparent plate 222 that functions as an IR cut filter or a low-pass filter, or both.

The objective downstream attachments 114 inserted in FIGS. 7 and 17 have telenegative optical characteristics and, starting from the object side, i.e. from left to right, respectively comprise the following lenses:

a) a first bi-concave lens 702, and

b) a second meniscus lens 706,

the concave surface 708 of the meniscus lens 706 being averted from the object side.

The air spaces between the last surface of the downstream attachments and the transparent plate 222 arranged therebehind are frequently 1 mm.

The first and the second lens of each basic objective 106 are cemented to one another and form a doublet. The two lenses 702, 706 of the respective telenegative objective downstream attachment 114 likewise form a doublet.

The diameters of the lenses of the objective downstream attachments 114 are at most 6 mm.

The surfaces 208 and 218 of the second and third lenses of each basic objective 106 have an aspheric surface.

The same holds for the surface 700 of the first lens 702 of each telenegative downstream attachment.

The precise specifications relating to the individual surfaces of the lenses of the exemplary embodiments in accordance with FIGS. 2, 7, 12 and 17 are to be found in tables 4, 6, 8 and 9, with the associated reference numbers in each case.

FIGS. 3 to 6 are graphs of some characteristic parameters for an 8 mm basic objective according to the exemplary embodiment in FIG. 2.

FIG. 3 shows the relative illuminance of the image compared with the center for the 8 mm basic objective according to FIG. 2. The x-axis specifies the relative deviation from the center of the image to be enlarged, in conjunction with an f-number of 3.5.

FIG. 4 shows the distortion for the basic objective according to the exemplary embodiment of FIG. 2 in percent (%) of the deviation from the ideal image size. The positive values characterize a pin-cushion distortion, while the negative values relate to a barrel distortion. The x-axis specifies the relative deviation from the center of the image to be enlarged, in conjunction with an f-number of 3.5.

FIG. 5 shows a graph of the transmission level in percent (%) for the basic objective according to the exemplary embodiment of FIG. 2, as a function of the wavelength.

FIG. 6 illustrates the resolution (modulation) of the projection objective of FIG. 2 as a function of the relative image size. The x-axis specifies the relative deviation from the center of the image in conjunction with an f-number of 3.5. The wavelengths were weighted as follows: 555 nm with 19.8%, 655 nm with 23.7%, 605 nm with 22.2%, 505 nm with 15.7%, 455 nm with 12.1% and 405 nm with 6.7%. Calculation was performed using the spatial frequencies of 25, 50 and 100 line pairs per mm (lp/mm). The continuous line respectively shows the resolution of radially running line pairs, and the dashed line shows the resolution of tangentially running line pairs. The modulation transfer function is illustrated on the y-axis in conjunction with an f-number k of 3.5.

The above explanations with regard to FIGS. 3 to 6 also hold, mutatis mutandis, for FIGS. 8 to 11, FIGS. 13 to 16 and FIGS. 18 to 21, the maximum f-numbers for FIGS. 8 to 11 and for FIGS. 18 to 21 being based on the appropriate multiplication factor (see above).

As FIGS. 3 to 6 show, the proposed basic objective has excellent imaging characteristics.

Table 1 sets forth which focal lengths can be implemented with the 6 basic objectives described as exemplary embodiments, or combinations of these basic objectives with four exemplary telenegative objective downstream attachments. The f-number is 3.5 in this case.

Tables 2 to 11A list the radii, the thicknesses or air spaces, the refractive indices and the Abbe numbers of all 6 basic objectives or all four objective downstream attachments. These tables likewise give the aspheric data thereof.

The surface of an aspherical lens can be described in general with the following formula:

$$z = \frac{{Cy}^{2}}{1 + \sqrt{1 - ( 1 + K ) \cdot {C}^{2} {y}^{2}}} + {A}_{4} {y}^{4} + {A}_{6} {y}^{6} + {A}_{8} {y}^{8} + {A}_{10} {y}^{10} + {A}_{12} {y}^{12}$$

in which
z specifies the sagitta (in mm) with reference to the plane perpendicular to the axis, that is to say the direction of the deviation from the plane perpendicular to the optical axis, i.e. in the direction of the optical axis.
C specifies the so-called vertex curvature. It serves to describe the curvature of a convex or concave lens surface, and it is calculated from the reciprocal of the radius.
y specifies the distance from the optical axis (in mm). y is a radial coordinate.
K specifies the so-called conic constant.
A₄, A₆, A₈, A₁₀, A₁₂ represent the so-called aspheric coefficients which are the coefficients of a polynomial expansion of the function for describing the surface of the asphere.

It is advantageous that the implementation of the described optical module, while maintaining the desired compactness, requires only a design with as few lenses as possible. This could be achieved by the selection of highly refractive materials (nₑ>1.65) for the first cemented component of the basic objective. Furthermore, by introducing plane surfaces into the basic objective it proved possible to optimize the costs and to alleviate tolerances.

The telenegative downstream attachments advantageously are composed only of a cemented component whose Abbe numbers should differ as much as possible.

### REFERENCE SYMBOLS

100 Camera module
102 Light input device
104 Carrier plate for basic objectives
106 Basic objective
108 Image sensor
110 Shift function (horizontal) for basic objectives
112 Carrier plate for telenegative downstream attachments
114 Telenegative downstream attachment
116 Shift function (horizontal) for telenegative downstream attachments
118 Optical axis
120 Shift function for image sensor
200 First surface of the lens 202
202 First lens of the basic objective
204 Second surface of the lens 202/first surface of the lens 206
206 Second lens of the basic objective
208 Second surface of the lens 206
212 Diaphragm
214 First surface of the lens 216
216 Third lens of the basic objective
218 Second surface of the lens 216
220 First surface of the transparent plate 222
222 Transparent plate upstream of the image sensor
224 Second surface of the transparent plate 222
700 First surface of the lens 702
702 First lens of the objective downstream attachment
704 Second surface of the lens 702/first surface of the lens 706
706 Second lens of the objective downstream attachment
708 Second surface of the lens 70

TABLE 1

| | | Designation of the basic objectives | | | | | |
|---|---|---|---|---|---|---|---|
| | | 6 mm | 7 mm | 8 mm | 10 mm | 12 mm | 15 mm |
| Focal lengths F | | 5.999 | 7.003 | 8.022 | 9.986 | 11.901 | 14.934 |
| of the basic | | | | | | | |
| objectives | | | | | | | |
| [mm] | | | | | | | |
| Focal lengths | TN1 | 6.344 | 7.322 | 8.516 | 10.707 | 13.186 | 16.421 |
| F of the | TN2 | 6.718 | 7.681 | 9.047 | 11.470 | 14.543 | 17.986 |
| combinations | TN3 | 6.963 | 7.917 | 9.395 | 11.972 | 15.457 | 19.032 |
| of basic | TN4 | 7.384 | 8.308 | 10.002 | 12.870 | 17.216 | 21.012 |
| objective | | | | | | | |
| with | | | | | | | |
| telenegative | | | | | | | |
| downstream | | | | | | | |
| attachment | | | | | | | |
| (TN) | | | | | | | |
| [mm] | | | | | | | |

TABLE 1A

| | Designation of the basic objectives | | | | | |
|---|---|---|---|---|---|---|
| | 6 mm | 7 mm | 8 mm | 10 mm | 12 mm | 15 mm |
| Air spaces | 0.300 | 1.300 | 1.300 | 2.000 | 2.000 | 4.000 |
| between the last | | | | | | |
| surface of the | | | | | | |
| basic objectives | | | | | | |
| and the first | | | | | | |
| surface of the | | | | | | |
| downstream | | | | | | |
| attachments TN1 | | | | | | |
| to TN4 | | | | | | |
| [mm] | | | | | | |

TABLE 2
Focal length = 5.999 mm

| | | Thicknesses | Refractive | |
|---|---|---|---|---|
| Reference | Radius | or air spaces | index | Abbe number |
| symbol | [mm] | [mm] | nₑ | νₑ |
| 200 | 1.910 | | | |
| 202 | | 0.730 | 1.886 | 39.72 |
| 204 | INFINITE | | | |
| 206 | | 0.300 | 1.723 | 28.73 |
| 208* | 1.457 | | | |
| | | 0.420 | 1.000 | |
| 212 | INFINITE | | | |
| | | 1.000 | 1.000 | |
| 214 | INFINITE | | | |
| 216 | | 0.590 | 1.519 | 61.79 |
| 218* | −4.183 | | | |
| | | 2.750 | 1.000 | |
| 220 | INFINITE | | | |
| 222 | | 0.500 | 1.519 | 61.79 |
| 224 | INFINITE | | | |

*= aspheric surface

TABLE 2A

| | |
|---|---|
| Reference | |
| numeral | Aspheric data |

| | | |
|---|---|---|
| 208 | C | 0.686342 |
| | K | 0.587688 |
| | A₄ | 0 |
| | A₆ | 0 |
| | A₈ | 0 |
| | A₁₀ | 0 |
| | A₁₂ | 0 |
| 218 | C | 0.239063 |
| | K | 3.237013 |
| | A₄ | −0.200000 * 10⁻⁰² |
| | A₆ | 0.650000 * 10⁻⁰³ |
| | A₈ | 0 |
| | A₁₀ | 0 |
| | A₁₂ | 0 |

TABLE 3
Focal length = 7.003 mm

| | | Thicknesses | Refractive | |
|---|---|---|---|---|
| Reference | Radius | or air spaces | index | Abbe number |
| symbol | [mm] | [mm] | nₑ | νₑ |
| 200 | 2.229 | | | |
| 202 | | 0.852 | 1.886 | 39.72 |
| 204 | INFINITE | | | |
| 206 | | 0.350 | 1.723 | 28.73 |
| 208* | 1.700 | | | |
| | | 0.490 | 1.000 | |
| 212 | INFINITE | | | |
| | | 1.167 | 1.000 | |
| 214 | INFINITE | | | |
| 216 | | 0.688 | 1.519 | 61.79 |
| 218* | −4.881 | | | |
| | | 3.209 | 1.000 | |
| 220 | INFINITE | | | |
| 222 | | 0.500 | 1.519 | 61.79 |
| 224 | INFINITE | | | |

*= aspheric surface

TABLE 3A

| | |
|---|---|
| Reference | |
| numeral | Aspheric data |

| | | |
|---|---|---|
| 208 | C | 0.588235 |
| | K | 0.587688 |
| | A₄ | 0 |
| | A₆ | 0 |
| | A₈ | 0 |
| | A₁₀ | 0 |
| | A₁₂ | 0 |
| 218 | C | −0.204876 |
| | K | 3.237013 |
| | A₄ | −0.125896 * 10⁻⁰² |
| | A₆ | 0.300527 * 10⁻⁰³ |
| | A₈ | 0 |
| | A₁₀ | 0 |
| | A₁₂ | 0 |

TABLE 4
Focal length = 8.022 mm

| | | Thicknesses | Refractive | |
|---|---|---|---|---|
| Reference | Radius | or air spaces | index | Abbe number |
| symbol | [mm] | [mm] | nₑ | νₑ |
| 200 | 2.521 | | | |
| 202 | | 0.830 | 1.886 | 39.72 |
| 204 | INFINITE | | | |
| 206 | | 0.530 | 1.734 | 27.68 |
| 208* | 1.940 | | | |
| | | 0.660 | 1.000 | |
| 212 | INFINITE | | | |
| | | 1.220 | 1.000 | |
| 214 | INFINITE | | | |
| 216 | | 0.790 | 1.519 | 61.79 |
| 218* | −5.570 | | | |
| | | 3.660 | 1.000 | |
| 220 | INFINITE | | | |
| 222 | | 0.500 | 1.519 | 61.79 |
| 224 | INFINITE | | | |

*= aspheric surface

TABLE 4A

| | |
|---|---|
| Reference | |
| numeral | Aspheric data |

| | | |
|---|---|---|
| 208 | C | 0.515464 |
| | K | 0.587688 |
| | A₄ | 0 |
| | A₆ | 0 |
| | A₈ | 0 |
| | A₁₀ | 0 |
| | A₁₂ | 0 |
| 218 | C | −0.179533 |
| | K | 3.237013 |
| | A₄ | 0 |
| | A₆ | 0 |
| | A₈ | 0 |
| | A₁₀ | 0 |
| | A₁₂ | 0 |

TABLE 5
Focal length = 9.986 mm

| | | Thicknesses | Refractive | |
|---|---|---|---|---|
| Reference | Radius | or air spaces | index | Abbe number |
| symbol | [mm] | [mm] | nₑ | νₑ |
| 200 | 3.150 | | | |
| 202 | | 1.000 | 1.886 | 39.72 |
| 204 | INFINITE | | | |
| 206 | | 0.710 | 1.734 | 27.68 |
| 208* | 2.424 | | | |
| | | 0.706 | 1.000 | |
| 212 | INFINITE | | | |
| | | 1.642 | 1.000 | |
| 214 | INFINITE | | | |
| 216 | | 0.983 | 1.519 | 61.79 |
| 218* | −6.959 | | | |
| | | 4.575 | 1.000 | |
| 220 | INFINITE | | | |
| 222 | | 0.500 | 1.519 | 61.79 |
| 224 | INFINITE | | | |

*= aspheric surface

TABLE 5A

| | |
|---|---|
| Reference | |
| numeral | Aspheric data |

| | | |
|---|---|---|
| 208 | C | 0.412541 |
| | K | 0.587688 |
| | A₄ | 0 |
| | A₆ | 0 |
| | A₈ | 0 |
| | A₁₀ | 0 |
| | A₁₂ | 0 |
| 218 | C | −0.143699 |
| | K | 3.237013 |
| | A₄ | 0 |
| | A₆ | 0 |
| | A₈ | 0 |
| | A₁₀ | 0 |
| | A₁₂ | 0 |

TABLE 6
Focal length = 11.901 mm

| | | Thicknesses | Refractive | |
|---|---|---|---|---|
| Reference | Radius | or air spaces | index | Abbe number |
| symbol | [mm] | [mm] | nₑ | νₑ |
| 200 | 3.780 | | | |
| 202 | | 1.090 | 1.886 | 39.72 |
| 204 | INFINITE | | | |
| 206 | | 0.950 | 1.734 | 27.68 |
| 208* | 2.909 | | | |
| | | 0.840 | 1.000 | |
| 212 | INFINITE | | | |
| | | 1.770 | 1.000 | |
| 214 | INFINITE | | | |
| 216 | | 1.180 | 1.519 | 61.79 |
| 218* | −8.350 | | | |
| | | 4.500 | 1.000 | |
| 220 | INFINITE | | | |
| 222 | | 0.500 | 1.519 | 61.79 |
| 224 | INFINITE | | | |

*= aspheric surface

TABLE 6A

| | |
|---|---|
| Reference | |
| numeral | Aspheric data |

| | | |
|---|---|---|
| 208 | C | 0.343761 |
| | K | 0.587688 |
| | A₄ | 0 |
| | A₆ | 0 |
| | A₈ | 0 |
| | A₁₀ | 0 |
| | A₁₂ | 0 |
| 218 | C | −0.119760 |
| | K | 3.237013 |
| | A₄ | 0 |
| | A₆ | 0 |
| | A₈ | 0 |
| | A₁₀ | 0 |
| | A₁₂ | 0 |

TABLE 7
Focal length = 14.934 mm

| | | Thicknesses | Refractive | |
|---|---|---|---|---|
| Reference | Radius | or air spaces | index | Abbe |
| symbol | [mm] | [mm] | nₑ | number νₑ |
| 200 | 4.725 | | | |
| 202 | | 1.360 | 1.886 | 39.72 |
| 204 | INFINITE | | | |
| 206 | | 1.180 | 1.734 | 27.68 |
| 208* | 3.636 | | | |
| | | 1.060 | 1.000 | |
| 212 | INFINITE | | | |
| | | 2.060 | 1.000 | |
| 214 | INFINITE | | | |
| 216 | | 1.800 | 1.519 | 61.79 |
| 218* | −10.438 | | | |
| | | 7.000 | 1.000 | |
| 220 | INFINITE | | | |
| 222 | | 0.500 | 1.519 | 61.79 |
| 224 | INFINITE | | | |

*= aspheric surface

TABLE 7A

| | |
|---|---|
| Reference | |
| numeral | Aspheric data |

| | | |
|---|---|---|
| 208 | C | 0.275028 |
| | K | 0.587688 |
| | A₄ | 0 |
| | A₆ | 0 |
| | A₈ | 0 |
| | A₁₀ | 0 |
| | A₁₂ | 0 |
| 218 | C | −0.095804 |
| | K | 3.237013 |
| | A₄ | 0 |
| | A₆ | 0 |
| | A₈ | 0 |
| | A₁₀ | 0 |
| | A₁₂ | 0 |

TABLE 8
TN1

| | | Thicknesses | Refractive | |
|---|---|---|---|---|
| Reference | Radius | or air spaces | index | Abbe number |
| symbol | [mm] | [mm] | nₑ | νₑ |
| 700* | −100.000 | | | |
| 702 | | 1.000 | 1.623 | 58.14 |
| 704 | 30.000 | | | |
| 706 | | 1.000 | 1.624 | 35.30 |
| 708 | 33.300 | | | |

*= aspheric surface

TABLE 8A

| | |
|---|---|
| Reference | |
| numeral | Aspheric data |

| | | |
|---|---|---|
| 700 | C | −0.01 |
| | K | 0 |
| | A₄ | 0.150000 * 10⁻⁰³ |
| | A₆ | 0 |
| | A₈ | 0 |
| | A₁₀ | 0 |
| | A₁₂ | 0 |

TABLE 9
TN2

| | | Thicknesses | Refractive | |
|---|---|---|---|---|
| Reference | Radius | or air spaces | index | Abbe number |
| symbol | [mm] | [mm] | nₑ | νₑ |
| 700* | −30.000 | | | |
| 702 | | 1.000 | 1.623 | 58.14 |
| 704 | 10.000 | | | |
| 706 | | 1.000 | 1.624 | 35.30 |
| 708 | 28.000 | | | |

*= aspheric surface

TABLE 9A

| | |
|---|---|
| Reference | |
| numeral | Aspheric data |

| | | |
|---|---|---|
| 700 | C | −0.033333 |
| | K | 0 |
| | A₄ | −0.200000 * 10⁻⁰³ |
| | A₆ | 0 |
| | A₈ | 0 |
| | A₁₀ | 0 |
| | A₁₂ | 0 |

TABLE 10
TN3

| | | Thicknesses | Refractive | |
|---|---|---|---|---|
| Reference | Radius | or air spaces | index | Abbe number |
| symbol | [mm] | [mm] | nₑ | νₑ |
| 700* | −20.000 | | | |
| 702 | | 1.000 | 1.623 | 58.14 |
| 704 | 10.000 | | | |
| 706 | | 1.000 | 1.624 | 35.30 |
| 708 | 29.000 | | | |

*= aspheric surface

TABLE 10A

| | |
|---|---|
| Reference | |
| numeral | Aspheric data |

| | | |
|---|---|---|
| 700 | C | −0.05 |
| | K | 0 |
| | A₄ | −0.300000 * 10⁻³ |
| | A₆ | 0 |
| | A₈ | 0 |
| | A₁₀ | 0 |
| | A₁₂ | 0 |

TABLE 11
TN4

| | | Thicknesses | Refractive | |
|---|---|---|---|---|
| Reference | Radius | or air spaces | index | Abbe number |
| symbol | [mm] | [mm] | nₑ | νₑ |
| 700* | −14.000 | | | |
| 702 | | 1.000 | 1.623 | 58.14 |
| 704 | 6.000 | | | |
| 706 | | 1.000 | 1.624 | 35.30 |
| 708 | 25.000 | | | |

*= aspheric surface

TABLE 11A

| | |
|---|---|
| Reference | |
| numeral | Aspheric data |

| | | |
|---|---|---|
| 700 | C | −0.071429 |
| | K | 0 |
| | A₄ | −0.300000 * 10⁻³ |
| | A₆ | −0.400000 * 10⁻⁴ |
| | A₈ | 0 |
| | A₁₀ | 0 |
| | A₁₂ | 0 |

1. A camera module for imaging an object onto an image sensor, light traversing a beam path between the object and image sensor, the camera module having the following:
a) at least two carrier plates,
a1) the first carrier plate bearing a plurality of basic objectives, comprising a plurality of lenses, with an optical axis
a2) the second carrier plate bearing a plurality of objective downstream attachments comprising a plurality of lenses;
b) each carrier plate having a preferred plane that is aligned perpendicular to the optical axis;
b1) the basic objectives on the first carrier plate being fixed at different heights with reference to their preferred plane;
b2) the objective downstream attachments on the second carrier plate being arranged at the same height with reference to their preferred plane;
c) the position of the carrier plates being variable in their preferred plane in such a way that different basic objectives and objective downstream attachments can be positioned in the beam path;
d) the carrier plates being arranged one above another in the beam path;
e) the basic objectives and the objective downstream attachments being designed in such a way that, by positioning different lens combinations of
e1) a basic objective alone, or
e2) a basic objective with an objective downstream attachment, it is possible to produce in the beam path a plurality of imaging optical systems of different focal lengths, the optical systems being suitable for imaging the object onto the image sensor;
e3) focusing being performed by means of changing the position of the image sensor along the optical axis; and
f) the basic objectives and the objective downstream attachments being designed in such a way that different lens combinations of a basic objective and an objective downstream attachment result in different focal lengths, the number of the lens combinations of different focal lengths exceeding the number of the basic objectives or downstream objective attachments on one of the carrier plates.

2. The camera module as claimed in claim 1,
characterized
in that, starting from the object side, the basic objective is composed of the following lenses:
a) a first plano-convex lens,
the plane surface of the lens being averted from the object side;
b) a second plano-concave lens,
the plane surface of the lens being averted from the image side;
c) a diaphragm, and
d) a third plano-convex lens, the plane surface of the lens being averted from the image side.

3. The camera module as claimed in claim 2,
characterized
in that the first plano-convex lens consists of a material with a refractive index greater than 1.65.

4. (canceled)

5. The camera module as claimed in claim 1
characterized
in that, starting from the object side, the objective downstream attachment comprises the following lenses:
a) a first bi-concave lens, and
b) a second meniscus lens,
the concave surface of the meniscus lens being averted from the object side.

6. The camera module as claimed in claim 5,
characterized
in that the Abbe numbers of the first bi-concave lens and of the second meniscus lens differ by at least a factor of 1.5.

7. (canceled)

8. The camera module as claimed in claim 1,
characterized
in that the distance between the first object-side lens surface of a basic objective and the image sensor is at most 19 mm.

9. The camera module as claimed in claim 1,
characterized
in that the diameter of the lenses of the basic objective and of the objective downstream attachments is at most 6 mm.

10. The camera module as claimed in claim 2
characterized
in that, starting from the object side, the objective downstream attachment comprises the following lenses:
a) a first bi-concave lens, and
b) a second meniscus lens,
the concave surface of the meniscus lens being averted from the object side.

11. The camera module as claimed in claim 3
characterized
in that, starting from the object side, the objective downstream attachment comprises the following lenses:
a) a first bi-concave lens, and
b) a second meniscus lens,
the concave surface of the meniscus lens being averted from the object side.

12. The camera module as claimed in claim 10,
characterized
in that the Abbe numbers of the first bi-concave lens and of the second meniscus lens differ by at least a factor of 1.5.

13. The camera module as claimed in claim 2,
characterized
in that the distance between the first object-side lens surface of a basic objective and the image sensor is at most 19 mm.

14. The camera module as claimed in claim 3,
characterized
in that the distance between the first object-side lens surface of a basic objective and the image sensor is at most 19 mm.

15. The camera module as claimed in claim 5,
characterized
in that the distance between the first object-side lens surface of a basic objective and the image sensor is at most 19 mm.

16. The camera module as claimed in claim 10,
characterized
in that the distance between the first object-side lens surface of a basic objective and the image sensor is at most 19 mm.

17. The camera module as claimed in claim 6,
characterized
in that the distance between the first object-side lens surface of a basic objective and the image sensor is at most 19 mm.

18. The camera module as claimed in claim 2,
characterized
in that the diameter of the lenses of the basic objective and of the objective downstream is at most 6 mm.

19. The camera module as claimed in claim 3,
characterized
in that the diameter of the lenses of the basic objective and of the objective downstream is at most 6 mm.

20. The camera module as claimed in claim 5,
characterized
in that the diameter of the lenses of the basic objective and of the objective downstream is at most 6 mm.

21. The camera module as claimed in claim 10,
characterized
in that the diameter of the lenses of the basic objective and of the objective downstream is at most 6 mm.

22. The camera module as claimed in claim 6,
characterized
in that the diameter of the lenses of the basic objective and of the objective downstream is at most 6 mm.

23. The camera module as claimed in claim 8,
characterized
in that the diameter of the lenses of the basic objective and of the objective downstream is at most 6 mm.

24. The camera module as claimed in claim 13,
characterized
in that the diameter of the lenses of the basic objective and of the objective downstream is at most 6 mm.

25. The camera module as claimed in claim 15,
characterized
in that the diameter of the lenses of the basic objective and of the objective downstream is at most 6 mm.
